(19) United States
(12) Patent Application Publication
(10) Pub. No.: US 2017/0163943 A1
(43) Pub. Date: Jun. 8, 2017

(54) METHOD AND APPARATUS FOR SMART HOME MONITORING AND SMART HOME SYSTEM

(71) Applicant: LE SHI ZHI XIN ELECTRONIC TECHNOLOGY (TIANJIN) LIMITED, Beijing (CN)

(72) Inventors: Kun DU, Beijing (CN); Jiangjie TANG, Beijing (CN); Qiang LI, Beijing (CN)

(73) Assignee: LE SHI ZHI XIN ELECTRONIC TECHNOLOGY (TIANJIN) LIMITED, Beijing (CN)

(21) Appl. No.: 15/039,411

(22) PCT Filed: Nov. 12, 2014
(86) PCT No.: PCT/CN2014/090909

§ 371 Date: May 25, 2016

(30) Foreign Application Priority Data
Nov. 27, 2013 (CN) 201310636305.7

(51) Int. Cl. H04N 7/18; H04L 12/28

(52) U.S. Cl. CPC H04N 7/186; H04L 12/2807

(57) ABSTRACT

A smart home monitoring method, apparatus, and smart home system, which improve monitoring efficiency and further enhance performance of human-computer interaction. The method may comprise: if, when a display device (1) is in standby, the display device detects a data signal sent by a sending device of the smart home, then the display device (1) being triggered by the data signal to power on, the data signal being used for characterizing the visitor's access information; the display device (1) receiving and storing the data signal.

### TECHNICAL FIELD

The present disclosure relates to the field of display technologies, and more particularly, to a method and an apparatus for smart home monitoring, and a smart home system.

### BACKGROUND

With the increasing of people's safety consciousness as well as more and more normative and precise management of people's residential quarters, a building intercom system serving as an access control system emerges at the right moment. The building intercom system may be mainly configured to control and manage the visiting process of visitors, and effectively prevent illegal personnel from approaching, so as to ensure the profits of users to implement security protection.

In the prior art, a receiving device of the building intercom system is usually installed at the gate of a residential quarter or unit, which may be configured to receive a visiting signal transmitted by a visitor and transmit the visiting signal to a transmitting device of the building intercom system. The transmitting device is generally installed at the gate of the residence of the user, and may be configured to transmit a monitoring operation instructed by the user to the receiving device. In the traditional building intercom system, when the user is in the residence thereof and when a visitor visits, the user may complete such monitoring operations as voice communication, video viewing and remote unlocking between the user and the visitor through the transmitting device.

However, the monitoring operation of the user on the building intercom system in the prior art is only applicable to a circumstance that the visitor visits when the user is in the residence thereof; therefore, when the user is not in the residence thereof, when a visitor visits, the access information of the visitor will be missed, so that the monitoring efficiency is low, which results in poor human-computer interaction performance.

### SUMMARY

Embodiments of the disclosure provide a method and an apparatus for smart home monitoring, and a smart home system, which may increase the monitoring efficiency, so as to improve the human-computer interaction performance.

The embodiments of the present disclosure disclose the following technical solutions.

According to an embodiment of the disclosure, a method for smart home monitoring, includes: when a display device is in standby, if the display device detects a data signal transmitted by a transmitting device of a smart home, triggering the display device to power on by the data signal, the data signal being configured to characterize an access information of a visitor; and receiving and storing the data signal by the display device.

According to another embodiment of the disclosure, a computer-readable record medium recording a program configured to conduct and implement the method for smart home monitoring abovementioned is disclosed.

According to another embodiment of the disclosure, a display device, includes: an enabling unit configured to, when the display device is in standby, if the display device detects a data signal transmitted by a transmitting device of a smart home, trigger the display device to power on according to the data signal, the data signal being configured to characterize the access information of a visitor; and a storing unit configured to, after the enabling unit triggers the display device to power on, receive and store the data signal.

According to another embodiment of the disclosure, a smart home system, includes: a plurality of smart home devices and the display device as described above, the plurality of smart home devices being connected to a signal source port of the display device respectively, wherein the smart home device includes a receiving device of the smart home and a transmitting device of the smart home, and the display device is a terminal integrated with a display function.

### BRIEF DESCRIPTION OF THE DRAWINGS

FIG. 1 is a flow chart of a method provided by embodiments of the present disclosure.

FIG. 2 is a flow chart of another method provided by embodiments of the present disclosure.

FIG. 3 is a structural drawing of a device provided by embodiments of the present disclosure.

FIG. 4 is a structural drawing of another device provided by embodiments of the present disclosure.

FIG. 5 is a structural drawing of another device provided by embodiments of the present disclosure.

FIG. 6 is an architecture drawing of a system provided by embodiments of the present disclosure.

### DETAILED DESCRIPTION

The implementation manners of the present disclosure will be explained in details with reference to the drawings and embodiments hereinafter, so that the realization process of how to solve the technical problems by using a technical means and achieve the technical efficacy can be sufficiently understood and implemented accordingly.

In the embodiments of the present disclosure, a main body for implementing a method for smart home monitoring provided by the embodiments of the present disclosure may be a smart home monitoring device, wherein the smart home monitoring device may be either a display device, or an independent module connected to the display device. The embodiments hereinafter are only explained by taking the smart home monitoring device as a display device for example. Wherein, the display device may include such devices capable of receiving a data signal transmitted by a transmitting device of the smart home as a smart TV, a computer, a tablet, a mobile phone, or the like.

### First Embodiment

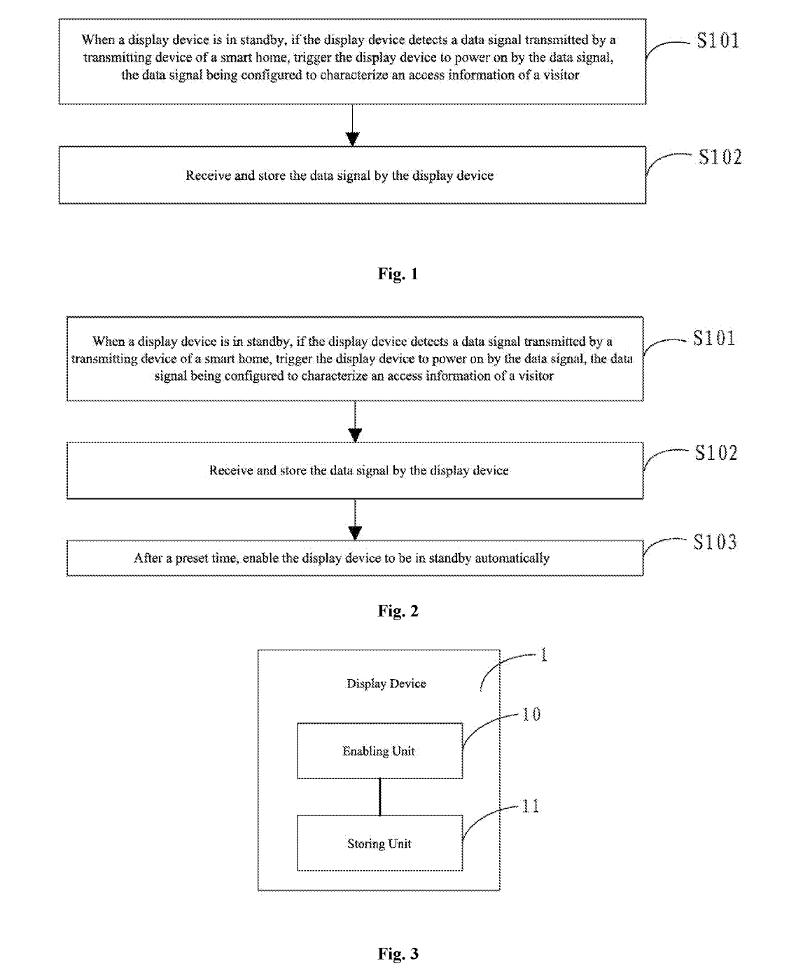

The embodiment of the present disclosure provides a method for smart home monitoring. As shown in FIG. 1, the method may include the following steps.

In step S101, when a display device is in standby, if the display device detects a data signal transmitted by a transmitting device of a smart home, the display device is triggered to power on by the data signal, the data signal being configured to characterize the access information of a visitor.

A smart home is based on a residence and utilizes integrated wiring technology, network communication technology, security protection technology for smart home-system design solution, automatic control technology as well as audio and video technologies and the like to integrate facilities associated with home life, and establishes an effective management system for residence facilities and family schedule transactions, so that the security, convenience, comfort and artistry of the home are improved, so as to implement an environmental-protection energy-conservation living environment. Wherein, the security protection technology is an indispensable technology to implement the smart home, which may be widely applied in such fields as visual intercom, home monitoring and family anti-theft alarm in quarters and residences, as well as family-related all-in-one card for quarters. The automatic control technology is also an indispensable technology to implement the smart home, which is widely applied in a smart home control center and an automatic control module of home equipment, and is very important for both the scientific management of home energies and the calendar management of household facilities.

In the embodiment of the present disclosure, the smart home connects various devices (such as audio and video devices, lighting system, curtain control, air conditioner controlling, security prevention system, access control system, digital cinema system, network household appliances and three-meter reading, or the like) at home together through Internet of Things, so as to provide various functions including household appliance control, lighting control, curtain control, telephone remote control, indoor and outdoor telecontrol, guest visiting management, anti-theft alarm, environmental monitoring, heating and ventilation control, infrared forwarding and programmable fixed-time control, or the like. Compared with an ordinary home, the smart home not only has the traditional residence function, but also has the functions of building, network communication, information household appliance and device automation, provides an effective, comfortable, secure, convenient and environment-friendly dwelling environment that integrates system, structure, service and management as a whole, and provides an all-oriented information interaction function, thus helping families keep smooth information communication with the outside, and optimize the life-style of people, so as to enable people to arrange time effectively, and enhance the security of the home life, and even store funds for various energy costs.

The embodiment of the present disclosure implements a basic access control system in the smart home, which is namely a building intercom system, wherein the building intercom system may include a receiving device and a transmitting device, i.e., the smart home may include a receiving device and a transmitting device.

In the embodiment of the present disclosure, the transmitting device of the smart home is used as an external signal source of the display device, so as to enable the display device to receive a data signal transmitted by the transmitting device.

The signal source refers to an instrument or device that outputs the data signal. If the display device is externally connected to the signal source, the data signal outputted from the signal source may be inputted into the display device and displayed, so that a user may view the data signal outputted from the signal source. Wherein, the display device and the external signal source are connected through a signal source port of the display device.

When the user is not in the residence thereof and the display device is in standby, if a visitor visits, the display device detects the data signal transmitted by the transmitting device, the data signal triggers the display device to power on, wherein the transmitting device is the transmitting device of the smart home, and the data signal is configured to characterize the access information of the visitor.

To be specific, when the display device is in standby, if a visitor visits the user, the visitor may trigger the receiving device of the smart home by operating a key, so that the receiving device transmits a second data signal to the transmitting device of the smart home through a system bus of the smart home, and the transmitting device may transmit the second data signal to the display device through the signal source port. The display device detects the data signal from the transmitting device. If the display device detects the data signal transmitted by the transmitting device, the display device generates a power-on instruction for the display device according to the data signal, and the display device is powered on according to the power-on instruction.

In one embodiment, because the data signal transmitted by the transmitting device may include a video signal and an audio signal, the access information of the visitor may be the image and voice of the visitor.

Particularly, the display device may be connected to the transmitting device of the smart home in a wired or wireless manner, so that the display device and the transmitting device may be communicated with each other.

In step S102, the display device receives and stores the data signal.

After the display device is triggered to power on by the data signal transmitted by the transmitting device, the display device receives and stores the data signal, so that the user when returning the residence thereof, may know the access information of the visitor through the data signal stored, so that smart home monitoring is implemented.

Further, the display device may either store the data signal in a storage area of the display device or in an external storage device of the display device, for instance, a U disk, an SD card (Secure Digital Memory Card, secure digital memory card) or a mobile hard disk drive. The user when returning the residence thereof, may open the display device, and know the identity of the visitor by viewing the image and voice of the visitor stored in the storage area of the display device or in the external storage device of the display device, so that smart home monitoring is implemented.

As shown in FIG. 2, the method for smart home monitoring provided by the embodiment of the present disclosure, in addition to the foregoing steps S101 and S102, further includes a step S103, wherein:

in step S103, after a preset time, the display device is in standby automatically.

After receiving and storing the data signal, the display device is in standby automatically after a preset time.

It should be illustrated that the preset time is a short period of time set by developers, for instance, five minutes, and the specific numerical value of the preset time is not limited in the present disclosure.

It is to be understood that the display device can both protect the environment and store the electricity since it may be in standby automatically after a preset time. After the display device receives a power-on instruction transmitted by the user through a control equipment (which may either be an independent control equipment or integrated on the display device), the display device is powered on according to the power-on instruction and prompts according to the data signal, and calls in the data signal to display after receiving a confirmation instruction.

The method for smart home monitoring provided by the embodiment of the present disclosure is explained hereinafter by means of examples.

When the user is not in the residence thereof and the display device is in standby, if a visitor A visits, the visitor A may trigger the receiving device of the smart home by operating a key corresponding to the room No. of the residence of the users, so that the receiving device transmits a data signal (i.e., the image and voice of the visitor A) through the system bus of the smart home to the transmitting device of the smart home, so that the transmitting device may transmit the data signal to the display device through the signal source port connected to the transmitting device, i.e., the display device receives the image and voice of the visitor A transmitted by the transmitting device. Therefore, the data signal triggers the display device to power on, and the display device stores the image and voice of the visitor A, and stores the image and voice of the visitor A in a U disk connected to the display device. After five minutes, the display device is in standby automatically. When the user returns the residence thereof and opens the display device, the display device displays that visitor A has visited, and prompts the user whether to view the data signal of the visitor A stored, so that the user may know the information of the visitor A, so that smart home monitoring is implemented.

According to the method for smart home monitoring provided by the embodiment of the present disclosure, when the display device is in standby, if the display device detects the data signal transmitted by the transmitting device of the smart home, the display device is triggered to power on by the data signal, the data signal being configured to characterize the access information of the visitor; and the display device receives and stores the data signal. According to the solution, when the user is not in the residence thereof and the display device is in standby, when a visitor visits, the display device may store the access information of the visitor for the user when returning the residence thereof to view the access information of the visitor; therefore, the user will not miss the access information of the visitor, so that the monitoring efficiency can be increased, so as to improve the human-computer interaction performance.

### Second Embodiment

As shown in FIG. 3, the embodiment of the present disclosure provides a display device 1, wherein the display device 1 may include an enabling unit 10 and a storing unit 11.

The enabling unit 10 is configured to, when the display device is in standby, if the display device detects a data signal transmitted by a transmitting device of a smart home, trigger the display device to power on according to the data signal, the data signal being configured to characterize the access information of a visitor.

The storing unit 11 is configured to, after the enabling unit 10 triggers the display device to power on, receive and store the data signal.

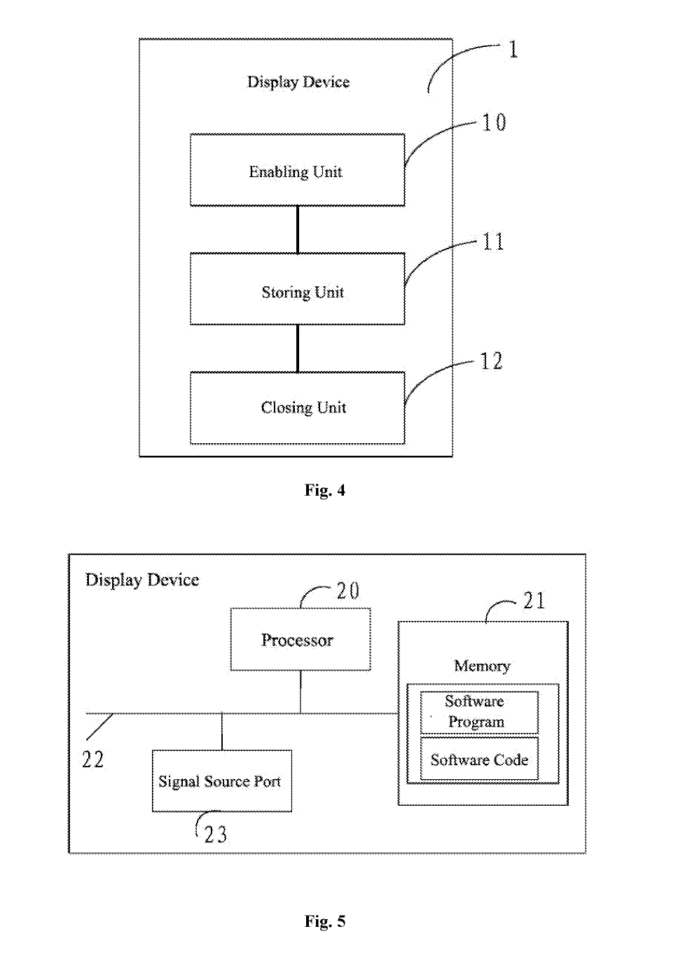

Optionally, as shown in FIG. 4, the display device 1 further includes a closing unit 12, wherein the closing unit 12 is configured to, after the storing unit 11 receives and stores the data signal, trigger the display device to be in standby automatically after a preset time.

Optionally, the storing unit 11 is specifically configured to store the data signal in a storage area of the display device or an external storage device of the display device.

Optionally, the enabling unit 10 is specifically configured to generate a power-on instruction according to the data signal and trigger the display device to power on according to the power-on instruction. The enabling unit 10 is further specifically configured to, after receiving the power-on instruction transmitted from a control equipment after the closing unit triggers the display device to be in standby automatically, power on the display device according to the power-on instruction and prompt according to the data signal, and call in the data signal to display after receiving a confirmation instruction.

It should be illustrated that because the display device can only receive and store the data signal after being triggered to power on by the data signal transmitted by the transmitting device, and the display device may be in standby automatically only after a preset time when the display device receives and stores the data signal, therefore, the enabling unit 10 is connected to the storing unit 11, and the storing unit 11 is connected to the closing unit 12.

The display device provided by the embodiment of the present disclosure may be a smart display device, wherein the smart display device may include such devices capable of receiving the data signal transmitted by the transmitting device of the smart home as a smart TV, a computer, a tablet, a mobile phone or the like.

According to the display device provided by the embodiment of the present disclosure, when the display device is in standby, if the display device detects the data signal transmitted by the transmitting device of the smart home, the display device is triggered to power on by the data signal, the data signal being configured to characterize the access information of the visitor; and the display device receives and stores the data signal. According to the solution, when the user is not in the residence thereof and the display device is in standby, if a visitor visits, the display device may store the access information of the visitor for the user when returning the residence thereof to view the access information of the visitor; therefore, the user will not miss the access information of the visitor, so that the monitoring efficiency can be increased, so as to improve the human-computer interaction performance.

### Third Embodiment

As shown in FIG. 5, the embodiment of the present disclosure provides a display device. The display device may include a processor 20, a memory 21, a system bus 22 and a signal source port 23, wherein:

the processor 20, the memory 21 and the signal source port 23 are connected through the system bus 22 and achieve mutual communications therebetween.

The processor 20 may be a single-core or multi-core central processing unit, or a specific integrated circuit, or be configured into one or more integrated circuits that implement the embodiment of the present disclosure.

The memory 21 may be a high speed RAM, or a non-volatile memory (non-volatile memory), for example, at least one magnetic disc memory.

The memory 21 is configured to store an execute instruction of the display device. To be specific, the execute instruction of the display device may include a software program and a software code.

The signal source port 23 may be configured to receive the data signal from an external signal source device.

To be specific, the processor 20 may be configured to, when the display device is in standby, if the data signal transmitted by the transmitting device of the smart home is detected through the signal source port 23, trigger the display device to power on through the system bus 22 according to the data signal, the data signal being configured to characterize the access information of the visitor, and receive and store the data signal after triggering the display device to power on. The memory 21 may be configured to store the software code of the data signal received from the signal source port 23 and control the software program of the display device for completing the foregoing process, so that the processor 20 may complete the foregoing process through executing the software program stored in the memory 21 and calling in the corresponding software code.

Optionally, the processor 20 is further configured to, after receiving and storing the data signal, trigger the display device to be in standby automatically after a preset time.

Optionally, the processor 20 is specifically configured to store the data signal in a storage area of the display device or an external storage device of the display device.

Optionally, the processor 20 is specifically configured to generate a power-on instruction through the system bus 22 according to the data signal, and trigger the display device to power on according to the power-on instruction. The processor 20 is further specifically configured to, after the display device is in standby automatically and receives the power-on instruction generated through the system bus 22 and transmitted from a control equipment, power on the display device according to the power-on instruction and prompt according to the data signal, and call in the data signal to display after receiving a confirmation instruction.

The display device provided by the embodiment of the present disclosure may be a smart display device, wherein the smart display device may include such devices capable of receiving the data signal transmitted by the transmitting device of the smart home as a smart TV, a computer, a tablet, a mobile phone or the like.

The embodiment of the present disclosure provides a display device, when the display device is in standby, if the display device detects the data signal transmitted by the transmitting device of the smart home, the display device is triggered to power on by the data signal, the data signal being configured to characterize the access information of the visitor; and the display device receives and stores the data signal. According to the solution, when the user is not in the residence thereof and the display device is in standby, if a visitor visits, the display device may store the access information of the visitor for the user when returning the residence thereof to view the access information of the visitor; therefore, the user will not miss the access information of the visitor, so that the monitoring efficiency can be increased, so as to improve the human-computer interaction performance.

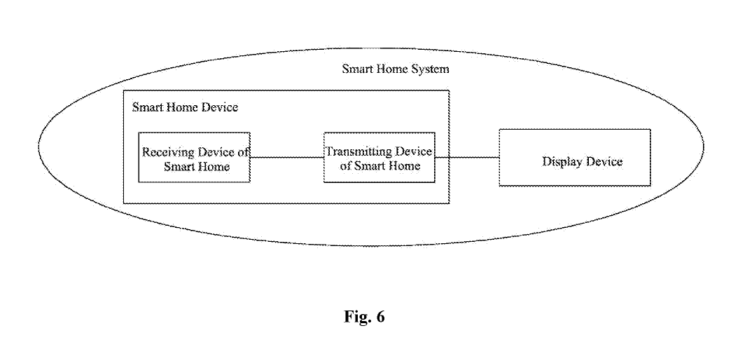

As shown in FIG. 6, the embodiment of the present disclosure further provides a smart home system, wherein the smart home system may include a plurality of smart home devices and a display device, the plurality of smart home devices being connected to a signal source port of the display device respectively, wherein the smart home device includes a receiving device of the smart home and a transmitting device of the smart home. When a user is not in the residence thereof and the display device is in standby, if a visitor visits, the receiving device of the smart home may transmit the image and voice of the visitor to the transmitting device of the smart home, the transmitting device of the smart home transmits the image and voice of the visitor inputted to the display device, and the display device is triggered to power on by the image and voice of the visitor, so that the display device may store the image and voice of the visitor in a storage area of the display device or an external storage device of the display device, so that the user after returning the residence thereof may view the image and voice of the visitor through the display device, and know that the visitor has visited. The display device is any terminal integrated with a display function, including but not limited to any one of a TV, a computer, a tablet and a mobile phone. The smart home system provided by the embodiment of the present disclosure enables to record the access of visitors when the user goes out, so as to implement an unattended smart home monitoring function and increase the monitoring efficiency, and further improve the computer-human interaction performance.

Those skilled in the art may clearly understand that, it is only illustrated by taking the division of each functional module above as an example for the purpose of convenient and simple description. In practical application, the foregoing function distribution may be finished by different functional modules according to requirements. That is, the interior of the apparatus is divided into different functional modules so as to finish all or part of the functions described above. For specific working processes of the apparatus described in the foregoing, reference may be made to corresponding processes in the foregoing method embodiments, which will not be elaborated herein.

In several embodiments of the present disclosure, it should be understood that the disclosed apparatus, and method may be implemented in other ways. For example, the apparatus embodiments described in the foregoing are only exemplary.

The units described may or may not be physically separated from each other, and the parts shown as units may be one or more physical units, that is, the parts may be located at the same place, or may also be distributed to multiple different places. A part or all of the units may be selected according to an actual requirement to achieve the objectives of the solutions in the embodiments.

In addition, function units in the embodiments of the present disclosure may be integrated into a processing unit, or each unit may exist singly and physically, or two or more units may be integrated in one unit. The unit integrated above may be implemented in the form of hardware, and may also be implemented in the form of a software function unit.

If the integrated unit is implemented in the form of a software function unit and is sold or used as an independent product, it may be stored in a readable storage medium. Based on such understanding, the technical solutions of the present disclosure essentially, or the part contributing to the prior art, or all or a part of the technical solutions may be embodied in the form of a software product. The software product is stored in a storage medium and includes several instructions for instructing a device (which may be a singlechip, a chip and so on) or a processor (processor) to execute all or a part of steps of the methods described in the embodiments of the present disclosure. While the abovementioned storage medium includes: any medium that is capable of storing program codes, such as a U disk, a mobile hard disk drive, a read-only memory (ROM, Read-Only Memory), a random access memory (RAM, Random Access Memory), a magnetic disk, or an optical disk.

The above description is merely the detailed implementation manner of the present disclosure, but not intended to limit the protection scope of the present disclosure. Any changes or replacements easily figured out by those skilled in the art without departing from the technical scope disclosed by the present disclosure shall fall within the protection scope of the present disclosure. Therefore, the protection scope of the present disclosure shall be subjected to the protection scope of the claims.

1. A method for smart home monitoring, comprising:
when a display device is in standby, if the display device detects a data signal transmitted by a transmitting device of a smart home, triggering the display device to power on by the data signal, the data signal being configured to characterize an access information of a visitor; and
receiving and storing the data signal by the display device.

2. The method for smart home monitoring according to claim 1, wherein after receiving and storing the data signal by the display device, the method further comprises:
after a preset time, enabling the display device to be in standby automatically.

3. The method for smart home monitoring according to claim 2, wherein the step of storing the data signal by the display device comprises:
storing the data signal in a storage area of the display device or an external storage device of the display device by the display device.

4. The method for smart home monitoring according to claim 3, wherein triggering the display device to power on by the data signal specifically comprises:
generating a power-on instruction for the display device by the display device according to the data signal; and
powering on the display device according to the power-on instruction.

5. The method for smart home monitoring according to claim 2, wherein after enabling the display device to be in standby automatically, the method further comprises:
after the display device receives the power-on instruction transmitted from a control equipment, powering on the display device according to the power-on instruction and prompting according to the data signal, and calling the data signal to display after receiving a confirmation instruction.

6. The method for smart home monitoring according to claims 1, wherein, the access information of the visitor comprises the image of the visitor and the voice of the visitor.

7. A computer-readable record medium recording a program configured to execute the method for smart home monitoring according to claim 1.

8. A display device, comprising:
an enabling unit configured to, when the display device is in standby, if the display device detects a data signal transmitted by a transmitting device of a smart home, trigger the display device to power on according to the data signal, the data signal being configured to characterize an access information of a visitor; and
a storing unit configured to, after the enabling unit triggers the display device to power on, receive and store the data signal.

9. The display device according to claim 8, wherein the display device further comprises a closing unit;
the closing unit being configured to, after the storing unit receives and stores the data signal, trigger the display device to be in standby automatically after a preset time.

10. The display device according to claim 8, wherein,
the storing unit is configured to store the data signal in a storage area of the display device or an external storage device of the display device.

11. The display device according to claim 10, wherein,
the enabling unit is configured to generate a power-on instruction according to the data signal and trigger the display device to power on according to the power-on instruction.

12. The display device according to claim 9, wherein,
the enabling unit is configured to, after receiving the power-on instruction transmitted from a control device after the closing unit triggers the display device to be in standby automatically, power on the display device according to the power-on instruction and prompt according to the data signal, and call the data signal to display after receiving a confirmation instruction.

13. A smart home system, comprising: a plurality of smart home devices and the display device according to claim 8, the plurality of smart home devices being connected to a signal source port of the display device respectively, wherein the smart home device comprises a receiving device of the smart home and a transmitting device of the smart home, and the display device is any terminal integrated with a display function.
